(19) United States
(12) Patent Application Publication
(10) Pub. No.: US 2025/0282132 A1
(43) Pub. Date: Sep. 11, 2025

(54) METHOD FOR PRODUCING A CURVED LAMINATED GLAZING

(71) Applicant: SAINT-GOBAIN GLASS FRANCE, COURBEVOIE (FR)

(72) Inventors: Jun TAN, SHANGHAI (CN); Juliette JAMART, COMPIEGNE (FR); Florian FLAMARY-MESPOULIE, COMPIEGNE (FR); Jun MA, SHANGHAI (CN)

(21) Appl. No.: 18/700,557

(22) PCT Filed: Oct. 10, 2022
(86) PCT No.: PCT/EP2022/078075

§ 371 Date: Apr. 29, 2025

(30) Foreign Application Priority Data
Oct. 12, 2021 (FR) FR2110796

(51) Int. Cl. B32B 38/18; B32B 1/00; B32B 7/12; B32B 17/10; B32B 38/00

(52) U.S. Cl. CPC B32B 38/1866; B32B 1/00; B32B 7/12; B32B 17/10036; B32B 17/1022; B32B 38/0036; B32B 38/145; B32B 2250/02; B32B 2255/20; B32B 2264/1025; B32B 2264/302; B32B 2264/303; B32B 2307/202; B32B 2307/304; B32B 2307/4026; B32B 2307/412; B32B 2605/00

(57) ABSTRACT

A method for obtaining a laminated curved glazing unit in which (a) a first glass sheet is provided, coated on at least part of one of its faces with a stack of thin layers, then (b), on part of the surface of the stack of thin layers, an enamel layer is deposited by screen-printing an enamel composition comprising 1 to 15% by weight of zinc oxide particles having a particle size distribution by volume such that the d90 is at most 5 μm. After lamination (d) with an additional glass sheet, the enamel layer is turned towards a lamination interlayer.

The invention relates to the field of curved laminated glazing units for motor vehicles, for example roofs or windshields, comprising a glass sheet coated with a stack of thin layers and an enamel layer.

Laminated glazing units are glazing units wherein two glass sheets are bonded adhesively using a lamination interlayer. The latter may particularly retain glass splinters in the event of breakage, but also provides other functionalities, particularly in terms of resistance to breakage or improved acoustic properties.

These glazing units often comprise coatings of various types, intended to confer different properties.

Enamel layers, generally black and opaque, are often deposited on part of the glazing unit, usually in the form of a peripheral strip intended to hide, and protect from ultraviolet radiation, the polymer seals used for attaching and positioning the glazing unit on the window opening of the vehicle body. Enameled zones also hide the zones for attaching the interior rear-view mirror and various connectors and sensors.

In a laminated glazing unit, these layers of enamel are generally arranged on face 2, the faces traditionally being numbered from the face intended to be positioned on the vehicle's exterior. Face 2 is therefore a face which is in contact with the lamination interlayer. The aesthetic appearance of the enamel layer, viewed from the outside of the vehicle, holds particular importance for car manufacturers. Enamel is generally obtained by firing a composition comprising a glass frit and pigments at above 500° C. A glass frit is composed of fine particles of glass with a low melting point which, under the effect of a firing heat treatment, softens and adheres to the glass sheet. A mineral layer, generally opaque, is thereby formed, with high chemical and mechanical strength, adhering perfectly to the glass while holding the pigment particles. The firing step is generally achieved simultaneously with the bending of the glass sheet.

In the context of laminated glazing unit manufacturing, the two glass sheets of the glazing unit are often curved together, with the glass sheet intended to be positioned on the inside of the vehicle generally being arranged above the other glass sheet, which carries the enamel. In other processes, each glass sheet is curved separately. In all cases, it is necessary that the enamel has non-stick properties in order to prevent any bonding between the two glass sheets or between the glass sheet and the bending tools during bending. To do this, usually enamels containing bismuth are used, that is obtained from glass frits containing bismuth oxide.

Coatings, generally in the form of stacks of thin layers, can also be present on one of the glass sheets of the laminated glazing. These can in particular be electrically conductive layers, which can provide two types of functionality. The electroconducting layers can on the one hand, when the provision of current is planned, dissipate heat through the Joule effect. This is layers for heating, useful for example for defrosting or defogging. On the other hand, these layers have, due to their reflection of infrared radiation, properties of sun control or low emissivity. The layers are valued for the improvement of thermal comfort or energy savings they provide, while reducing the consumption intended for heating or air conditioning. These stacks of layers are generally arranged on face 3 of the laminated glazing unit, therefore also in contact with the lamination interlayer.

It can however be interesting, in some cases that will be described in what follows, to arrange the layer of enamel and the stack of thin layers on the same glass sheet, and therefore on the same face of the glass sheet in question so that these coatings are protected on the inside of the laminated glazing.

However it has been observed that when a glass sheet coated with a stack of thin layers had to be provided with a layer of enamel, undesirable interactions could occur while the bending occurs between the stack and the enamel, leading in particular to degradation in the aesthetic appearance of the enamel. It has in particular been observed, particularly when the stack contained at least one layer of nitride and the enamel contained bismuth, that bubbles formed within the enamel, near the interface between it and the stack, causing a significant drop in the enamel adhesion, changing its optical appearance (particularly the color on the glass side, that is on the side opposite the enamel) and reducing its chemical resistance, particularly its acid-resistance.

Several solutions to this problem have been proposed.

It is possible to remove beforehand the stack of thin layers at the locations where the enamel layer is to be deposited, for example by means of abrasives, in order for the enamel to be deposited in direct contact with the glass sheet and to prevent any problems of adhesion between the enamel layer and the stack of thin layers. However, mechanical abrasion produces visible scratches, including on the enamel layer.

Application WO2014/133929, and earlier application WO0029346, have proposed the concept of using, for the enamel, special glass frits which, during firing or pre-firing, are capable of dissolving the stack of thin layers to become directly attached to the glass. However these enamels do not have good antiadhesive properties, and during the bending cause the two glass sheets to adhere together.

Application WO 2019/106264 proposes modifying the stack of thin layers by adding a layer of oxide between the stack and the enamel comprising bismuth. However, it is not always possible to make such a change.

The aim of the invention is to overcome these drawbacks.

To that end, a subject matter of the invention is a method for obtaining a curved laminated glazing unit, especially for a windshield or roof of a motor vehicle, comprising the following successive steps:
a. providing a first glass sheet, covered on at least part of one of its surfaces with a stack of thin layers,
b. a step of depositing, on a part of the surface of the stack of thin layers, a layer of enamel, the deposition being carried out by screen-printing an enamel composition comprising 1 to 15% by weight of zinc oxide particles having a particle size distribution by volume such that d90 is at most 5 μm,
c. a step of bending the first glass sheet, the stack of thin layers under the enamel layer being completely dissolved by said enamel layer at least at the end of this step, then
d. a step of laminating said first glass sheet with an additional glass sheet by means of a lamination interlayer, so that the enamel layer faces said interlayer.

Another subject matter of the invention is a curved laminated glazing unit, especially for a windshield or roof of a motor vehicle, obtained or obtainable by this method. This glazing unit comprises a first glass sheet covered on at least part of one of its faces with a stack of thin layers coated on part of its surface with an enamel layer comprising zinc oxide particles having a particle size distribution by volume such that d90 is at most 5 μm, said first glass sheet being laminated with a further glass sheet by means of a lamination interlayer, said enamel layer facing said lamination interlayer.

The use of zinc oxide particles makes it possible to reduce the mechanical embrittlement of the glass by the enamel and to improve the optical properties of the enamel, while reducing the risk of bonding during bending, either between the two glass sheets or between the glass sheet and the bending tools, depending on the bending method used.

In the present text, the stack of thin layers and the enamel layer are collectively called “the coatings”.

### Step a

The first glass sheet may be flat or curved. The first glass sheet is generally flat during the deposition of the stack of thin layers and then the enamel layer, and is then curved during step c. The first glass sheet is therefore bent into the curved laminated glazing unit according to the invention.

The glass of the first glass sheet is typically a silico-sodo-calcium glass, but other glasses, for example borosilicates or aluminosilicates, may also be used. The first glass sheet is preferably obtained by the float method, that is by a method consisting of pouring molten glass onto a bath of molten tin.

The first glass sheet may be made of clear glass or tinted glass, preferably of tinted glass, for example green, gray or blue. To this end, the chemical composition of the first glass sheet advantageously comprises iron oxide, in a content by weight ranging from 0.5 to 2%. It may also comprise other coloring agents, such as, for example, cobalt oxide, chromium oxide, nickel oxide, erbium oxide or else selenium.

The first glass sheet preferably has a thickness comprised in a domain ranging from 0.7 to 19 mm, especially from 1 to 10 mm, particularly from 2 to 6 mm, even from 2 to 4 mm.

The lateral dimensions of the first glass sheet (and of the additional glass sheet) are to be adapted according to those of the laminated glazing unit to which they are intended to be integrated. The first glass sheet (and/or the additional glass sheet) preferably have a surface area of at least 1 m².

The first glass sheet is preferably coated with the stack of thin layers over at least 70%, especially over at least 90%, or even over the whole of the surface of the face of the glass sheet. Some zones might not be coated so as to arrange communication windows allowing waves to pass.

The stack is preferably coated with the enamel layer over 2 to 25%, especially 3 to 20%, or even 5 to 15% of the surface thereof. The enamel layer preferably comprises a peripheral strip, i.e. a self-contained strip which, at any point of the periphery of the first glass sheet, extends inwardly towards the first glass sheet over a certain width, which generally may vary, typically between 1 and 20 cm depending on the zones of the final glazing.

The stack of thin layers is preferably in contact with the interior glass sheet. When being deposited, the enamel layer is preferably in contact with the stack of thin layers.

In the present text, “contact” is intended to mean physical contact. The expression “based on” is preferably intended to mean the fact that the layer in question comprises at least 50% by weight of the material in question, especially 60%, or even 70% and even 80% or 90%. The layer may even substantially consist of, or consist of, this material. “Substantially consist of” should be understood to mean that the layer may comprise impurities which have no influence on its properties. The terms “oxide” or “nitride” do not necessarily mean that the oxides or nitrides are stoichiometric. Indeed, they may be substoichiometric, superstoichiometric or stoichiometric.

The stack preferably comprises at least one layer based on a nitride. The nitride is particularly a nitride of at least one element selected from aluminum, silicon, zirconium, titanium. It may comprise a nitride of at least two or three of these elements, for example a silicon zirconium nitride or a silicon aluminum nitride. The layer based on a nitride is preferably a layer based on silicon nitride, more particularly a layer consisting substantially of a silicon nitride. When the layer of silicon nitride is deposited by cathode sputtering, it generally contains aluminum because it is common practice to dope silicon targets with aluminum in order to accelerate the deposition rates.

The layer based on a nitride preferably has a physical thickness in a range extending from 2 to 100 nm, especially from 5 to 80 nm.

The layers based on nitride are commonly used in a large number of stacks of thin layers since they have advantageous blocking properties, in that they prevent the oxidation of other layers present in the stack, especially functional layers which will be described below.

The stack preferably comprises at least one functional layer, especially an electrically conductive functional layer. The functional layer is preferably included between two thin dielectric layers, at least one of which is a layer based on nitride. Other possible dielectric layers are for example layers of oxides or oxynitrides.

At least one electrically conductive functional layer is advantageously selected from:
metal layers, particularly silver, niobium, even gold layers, and
layers of a transparent conductive oxide, especially selected from indium tin oxide, doped tin oxides (for example doped with fluorine or antimony), and doped zinc oxides (for example doped with aluminum or gallium).

These layers are particularly valued for their low emissivity, which gives the glazing units excellent thermal insulation properties. In glazing units equipping land vehicles, especially motor vehicles, trains, and also aircraft or seafaring vessels, low-emissivity glazing units make it possible, in hot weather, to outwardly reflect part of the solar radiation, and therefore to limit the heating of the passenger compartment of said vehicles, and where appropriate to reduce air-conditioning costs. Conversely, in cold weather, these glazing units make it possible to retain the heat within the passenger compartment, and consequently to reduce the heating energy required. The same applies in the case of glazing units equipping buildings.

According to a preferred embodiment, the stack of thin layers comprises at least one layer of silver, particularly one, two, three, or even four layers of silver. The physical thickness of the layer of silver or, where appropriate, the sum of the thicknesses of the layers of silver, is preferably between 2 and 50 nm, especially between 3 and 40 nm.

According to another preferred embodiment, the stack of thin layers comprises at least one layer of indium and tin oxide. The physical thickness thereof is preferably between 30 and 200 nm, especially between 40 and 150 nm.

In order to protect the or each electrically conductive thin layer (whether metallic or based on transparent conductive oxide) during the bending step, each of these layers is preferably surrounded by at least two dielectric layers. The dielectric layers are preferably based on oxide, nitride and/or oxynitride of at least one element selected from silicon, aluminum, titanium, zinc, zirconium, and tin.

At least part of the stack of thin layers can be deposited by various known techniques, for example chemical vapor deposition (CVD), or by cathode sputtering, especially magnetic-field-assisted (magnetron method).

The stack of thin layers is preferably deposited by cathode sputtering, particularly magnetron sputtering. In this method, a plasma is created in a high vacuum close to a target comprising the chemical elements to be deposited. By bombarding the target, the active species of the plasma tear off said elements, which are deposited on the glass sheet, forming the desired thin layer. This method is called a “reactive” method when the layer is made of a material resulting from a chemical reaction between the elements torn off from the target and the gas contained in the plasma. The major advantage of this method lies in the possibility of depositing a very complex stack of layers on the same line by making the glass sheet run in succession beneath various targets, generally in the same device.

The abovementioned examples have properties of electrical conduction and infrared reflection which are of use for providing a heating function (defrosting, defogging) and/or a thermal insulation function.

When the stack of thin layers is intended to provide a heating function, supplies of current must be provided. This may especially be strips of silver paste deposited by screen printing on the stack of thin layers, at two opposite edges of the glass sheet.

### Step b

In the present text, “enamel composition” is used to describe the liquid composition which is used, during step b, to deposit a wet enamel layer on the glass sheet. The term “enamel layer” is used to describe the layer at each stage of the method, both the wet layer (before possible pre-firing, if necessary before drying) and the final layer (after firing).

In step b, the enamel layer is preferably deposited from an enamel composition comprising at least one pigment, at least one glass frit, and zinc oxide particles. The enamel composition, like the enamel layer, preferably does not comprise lead oxide.

The enamel composition generally further comprises an organic medium, intended to facilitate the application of the composition on the substrate and also the temporary adhesion thereof to same, and which is eliminated if necessary during the pre-firing or firing of the enamel. The medium typically comprises solvents, diluents, oils and/or resins.

The glass frit is able to dissolve the underlying layer stack. Preferably the glass frit is based on bismuth zinc borosilicate (or borate). When it is desired that the enamel be capable of dissolving the stack of thin layers during pre-firing or firing, as described in more detail in the rest of the text, the proportions of bismuth and/or boron are preferably higher than those in the glass frits usually employed in order to make it more “aggressive” with respect to the stack of layers.

The pigments preferably comprise one or more oxides selected from oxides of chromium, copper, iron, manganese, cobalt, and nickel. These may be, by way of example, copper and/or iron chromates.

“Zinc oxide particles” means particles consisting or essentially consisting of zinc oxide (impurities possibly being present). This term therefore does not cover particles of glass frit, which may contain zinc oxide in its composition.

“d90” is conventionally understood to mean the value such that 90% of the particles (by volume) have a size smaller than this value. The particle size distribution by volume of the particles is preferably determined by laser particle size analysis.

Preferably, the zinc oxide particles have a particle size distribution by volume such that d90 is at most 3 μm, especially at most 1 μm.

Preferably, the zinc oxide particles have a volume particle size distribution such that the d50 is between 200 and 900 nm, especially between 300 and 800 nm.

The proportion of zinc oxide particles in the enamel composition is preferably between 2 and 10% by weight, especially between 3 and 8% by weight.

Advantageously, the enamel composition further comprises refractory particles having a diameter of at least 20 μm in a volume proportion of at least 0.5%, but not particles having a diameter greater than 80 μm.

“Refractory particles” refers to particles whose morphology is not significantly affected during the bending. These particles must have a melting or softening temperature well above the temperatures experienced during bending, and must not be dissolved by the frit. The refractory particles are especially based on metal oxides or metals. The metal oxides especially are simple oxides, such as aluminum oxide, titanium oxide or zirconium oxide, or complex oxides such as high-melting-point glass frits or inorganic pigments (the latter are especially called “complex inorganic color pigments” or CICP).

The presence of a sufficient proportion of “large” refractory particles (so the size, also called diameter, is at least 20 μm) also makes it possible to prevent the glass sheets from bonding together during bending, or the glass sheet from bonding to the bending tools. Due to their size, the large refractory particles create a morphology during bending in which the particles form peaks, with the molten or softened glass frit collecting in the valleys. This size of 20 μm and more is much larger than that of the glass frit and the pigments conventionally used.

The volume proportion of refractory particles with a size (or diameter) of 20 μm and above is preferably determined by laser diffraction particle sizing. This proportion is at least 0.5% and preferably at least 1%, especially at least 2% and even at least 3%.

Preferably, the enamel composition contains refractory particles with a diameter of at least 30 μm, especially at least 40 μm, and even at least 50 μm, in the above-mentioned volume proportions.

Another way to easily detect the presence of large particles, is to measure the fineness of the particles with a Hegman gage (or grind gage). According to this method, the fineness of the enamel composition, measured with a Hegman gage, is between 20 and 80 μm, especially between 40 and 60 μm.

Preferably, the enamel composition does not contain particles (refractory or not) with a diameter greater than 80 μm, in order to allow for proper deposition by screen printing. The presence of such particles can be determined by laser diffraction particle sizing or with a Hegman gage.

The enamel layer is deposited by screen printing. To this end, a screen printing screen is placed on the glass sheet, which screen comprises meshes, some of which are blocked off, then the enamel composition is deposited on the screen, then a squeegee is applied in order to force the enamel composition through the screen in the zones where the screen meshes have not been blocked off, so as to form a wet enamel layer. In order to ensure homogeneous deposition of the large refractory particles, when the enamel composition contains them, the mesh opening of the screen is preferably at least 40 μm, especially at least 60 μm, or even at least 70 μm. A mesh opening that is too small will trap the particles and prevent their homogeneous deposition, while a mesh opening that is too large will lead to a too high enamel thickness that may weaken the glass mechanically. The mesh opening is preferably at most 100 μm, especially at most 80 μm.

The thickness of the layer of wet enamel is preferably between 15 and 40 μm, especially between 20 and 30 μm.

Step b is preferably immediately followed by a drying step, intended to remove at least part of the solvent contained in the enamel composition. Such drying is typically carried out at a temperature of between 120 and 180° C.

### Step c

Bending may especially be carried out using gravity (the glass deforms under its own weight) or through pressing, at temperatures typically ranging from 550 to 650° C.

According to a first embodiment, the two glass sheets (first glass sheet and additional glass sheet) are curved separately. In this case, it is important to avoid any bonding between the first glass sheet and the bending tools.

According to a second embodiment, the first glass sheet and the additional glass sheet are curved together, with the enamel layer facing said additional glass sheet. In this case, it is important to avoid any bonding between the two glass sheets. The glass sheets are preferably kept apart by placing an interlayer powder between them to ensure a gap of a few tens of micrometers, typically 20 to 50 μm. The interlayer powder is for example based on calcium and/or magnesium carbonate. During the bending, the inner glass sheet (intended to be positioned inside the passenger compartment) is normally placed above the exterior glass sheet. Thus, during the bending step, the additional glass sheet is placed above the first glass sheet.

Preferably, after step c, the enamel layer is opaque, with a black hue. The lightness L* thereof, measured in reflection on the side of the glass, is preferably less than 5. It was observed that the addition of zinc oxide particles made it possible to reduce the value of the lightness L*, and therefore to obtain an enamel of a deeper black.

As indicated above, the enamel layer advantageously forms a strip at the periphery of the first glass sheet. The enamel layer is thereby capable of hiding and protecting seals, connecting elements or else sensors from ultraviolet radiation.

### Optional Pre-Firing Step (b1)

The method preferably comprises, between step b) and step c), a step b1) of pre-firing the enamel layer during which the thin layer stack below the enamel layer is at least partially dissolved by said enamel layer.

This step is particularly useful in the second embodiment described above, wherein the first glass sheet and the additional glass sheet are curved together, the enamel layer facing the additional glass sheet.

The dissolution of the thin layer stack by the enamel prevents the above-mentioned interactions. The components of the stack are dissolved in the enamel layer, which is in direct contact with the glass sheet at least after the bending step (step c).

If the enamel layer has not already completely dissolved the thin layer stack after the pre-firing, this total dissolution is achieved during the bending process, which completes the enamel firing.

The total dissolution of the stack of thin layers can especially be observed by electron microscopy. Electrical measurements, especially square resistance, also allow the dissolution of the stack to be determined.

The pre-firing step is preferably carried out at a temperature of between 150 and 800° C., especially between 500 and 700° C.

Such a pre-firing allows the removal of the organic medium, or in general any organic component that may be present in the enamel layer.

During the pre-firing, the thin layer stack is preferably at least partially dissolved by the enamel layer. Depending on the temperature used and the type of enamel or stack, the stack may even be completely dissolved by the enamel layer during the pre-firing. Alternatively, it may be only partially dissolved during pre-cooking, and is then completely dissolved during bending (step c).

### Step d

The lamination step may be carried out by treatment in an autoclave, for example at temperatures from 110 to 160° C. and under a pressure ranging from 10 to 15 bar. Prior to the autoclave treatment, the air trapped between the glass sheets and the lamination interlayer can be eliminated by calendering or by applying negative pressure.

As stated above, the additional sheet is preferably the interior sheet of the laminated glazing unit, that is the sheet located on the concave side of the glazing unit, intended to be positioned inside the passenger compartment. Thus, the coatings are arranged on face 2 of the laminated glazing.

The additional glass sheet may be made of silico-sodo-calcium glass, or of borosilicate or aluminosilicate glass. It may be made of clear or tinted glass. Its thickness is preferably between 0.5 and 4 mm, especially between 1 and 3 mm.

According to a preferred embodiment, the additional glass sheet has a thickness comprised between 0.5 and 1.2 mm. The additional glass sheet is especially made of sodium aluminosilicate glass, preferably strengthened chemically. The additional glass sheet is preferably the inner sheet of the laminated glazing. The invention is particularly useful for this type of configuration, for which it is difficult to arrange the stack of thin layers on face 3. Chemical strengthening (also called “ion exchange”) consists in putting into contact the glass surface with a molten potassium salt (for example potassium nitrate), so as to strengthen the surface of the glass by exchanging ions of the glass (here sodium ions) with ions with a larger ionic radius (here potassium ions). This ion exchange allows compression stresses to form on the surface of the glass and over a certain thickness. Preferably, the surface stress is at least 300 MPa, especially 400 and even 500 MPa, and at most 700 MPa, and the thickness of the compression zone is at least 20 μm, typically between 20 and 50 μm. The stress profile can be determined in a known manner using a polarizing microscope equipped with a Babinet compensator. The step of chemical tempering is preferably achieved at a temperature ranging from 380 to 550° C., and for a duration ranging from 30 minutes to 3 hours. The chemical strengthening is preferably achieved after the bending step but before the lamination step. The glazing unit obtained is preferably a motor vehicle windshield, particularly a heated windshield.

According to another preferred embodiment, the additional glass sheet bears on the face opposite the face turned towards the lamination interlayer (preferably face 4, the additional sheet being the inner sheet) a stack of additional thin layers, especially a stack with low emissivity, comprising a transparent conductive oxide, especially indium and tin oxide (ITO). The invention is also particularly useful for this type of configuration, for which it is delicate to arrange stacks of thin layers onto the two faces of the same glass sheet (face 3 and 4). In this embodiment, the lamination interlayer and/or the additional glass sheet is preferably tinted, the glass sheet bearing the coatings can be made of clear glass. The glazing unit obtained is preferably a motor vehicle roof.

As an example of the latter preferred embodiment, mention may be made of a laminated curved roof comprising, from the outside of the vehicle, a clear glass sheet coated on face 2 with a stack of thin layers comprising at least one silver layer then an enamel layer, a lamination interlayer made of PVB (preferably tinted), and an additional glass sheet made of tinted glass, bearing, on face 4, a low-emissivity stack of thin layers, especially based on ITO.

The lamination interlayer preferably comprises at least one sheet of polyvinyl acetal, especially polyvinyl butyral (PVB).

The lamination interlayer may be tinted or untinted in order, if necessary, to regulate the optical or thermal properties of the glazing unit.

The lamination interlayer may advantageously have acoustic absorption properties in order to absorb airborne or structure-borne sounds. To this end, it may especially consist of three polymeric sheets, including two “external” PVB sheets surrounding an internal polymeric sheet, optionally made of PVB, with a lower hardness than that of the external sheets.

The lamination interlayer may also have thermal insulation properties, in particular properties of infrared radiation reflection. To this end, it may comprise a coating of thin layers with low-emissivity, for example a coating comprising a thin layer of silver or a coating alternating dielectric layers with different refractive indices, deposited on an internal PET sheet surrounded by two external PVB sheets.

The thickness of the lamination interlayer is generally within a range extending from 0.3 to 1.5 mm, especially from 0.5 to 1 mm. The lamination interlayer can have a smaller thickness on an edge of the glazing unit than at the center of the glazing unit in order to prevent the formation of a double image in the case of using a head-up display (HUD).

### Examples

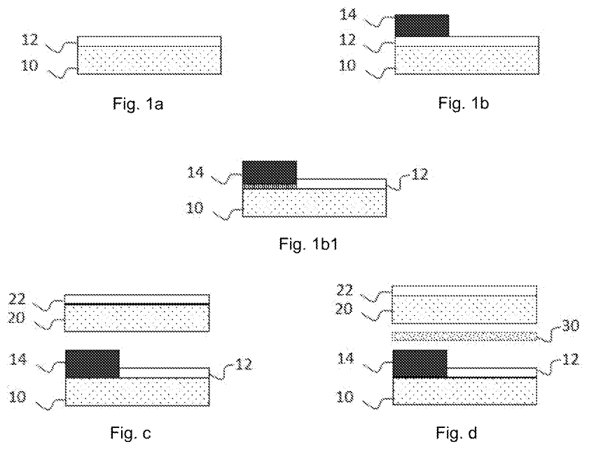

The following exemplary embodiments show the invention in a non-limiting manner, in connection with FIG. 1.

FIG. 1 schematically illustrates an embodiment of the method according to the invention. It shows a schematic cross-section of a portion of the glass sheets and the elements deposited on the glass sheets near their periphery. The various elements are obviously not represented at scale, so as to be able to visualize them.

The first glass sheet 10 coated with the thin film stack 12 is provided in step a, and then part of the stack 12 is coated with an enamel layer 14, especially by screen printing (step b).

The assembly then undergoes a pre-firing (step b1), which in the illustrated case leads to a partial dissolution of the stack 12 by the enamel 14.

An additional glass sheet 20, herein provided with a further thin layer stack 22, is then placed on the first glass sheet 10, the assembly then being curved (step c). The view shown being only that of the end of the glass sheet, the bending is not shown here. The diagram illustrates that, after bending, the enamel 14 has completely dissolved the underlying thin layer stack 12.

In step d, the first glass sheet 10 coated with the thin film stack 12 and the enamel layer 14 and the additional glass sheet 20 coated with the additional stack 22 are joined together with the aid of the laminating interlayer 30. The diagram here represents each of the separate elements, in an exploded view.

### First Series of Examples

The method used in the first series of examples corresponds to the embodiment shown in FIG. 1.

Clear glass sheets 2.1 mm thick, coated beforehand by cathode sputtering of a stack of thin layers comprising three silver layers protected by zinc oxide layers, silicon nitride layers and NiCr blockers, were partially coated by screen printing with enamel layers with a wet thickness of 25 μm.

The enamel composition comprised, in addition to the glass frit, black and medium pigments, 5% by weight of large refractory oxide particles having a size greater than 20 μm. In a first example according to the invention, 5% by weight of ZnO particles (D90<1 μm) was also added to the enamel composition.

The enamel layer was deposited by screen printing, then the enamel was dried (150° C., 1 to 2 minutes) before being pre-fired at about 650-680° C.

After pairing with an additional glass sheet of tinted soda-lime glass with a stack comprising an ITO layer on face 4, the assembly was curved at over 600° C. for 350 to 500 seconds.

After firing, the appearance, more particularly the black color viewed from face 1, was evaluated by measuring the lightness L* in reflection (illuminant D65, reference observer 10°).

In the case of the example according to the invention, the value L* obtained was on average 4.5, as opposed to 5.1 for the comparative example (without ZnO particles). The comparative example further had a slight haze in reflection, contrary to the example according to the invention.

For the comparative example, approximately 25% of the glasses broke at the corners at the moment of bending, with bonding observed, as well as a transfer of the enamel on the opposite glass. No breaking was on the other hand observed for the example according to the invention.

The laminated glazing units also underwent 3-point bending tests. For the comparative example, the force at break was 128 N, in contract with 172 N for the example according to the invention. The values given are mean values for a sample of 20 glazing units.

### Second Series of Examples

The examples of this second series of examples differ from those of the first series in that the bending of the two glass sheets was carried out separately, by pressing at a temperature of 610-630° C.

As for the first series, the enamel composition comprised, in addition to the glass frit, black pigments and medium, 5% by weight of large refractory oxide particles having a size greater than 20 μm. In a second example according to the invention, 5% by weight of ZnO particles (D90<1 μm) was also added to the enamel composition. A third example according to the invention contained 10% by weight of such particles.

In the case of the comparative example (without ZnO particles), the glass bonding to the bending tool was observed. This was not the case for the examples according to the invention.

1. A method for obtaining a curved laminated glazing unit, comprising the following successive steps:
a. providing a first glass sheet, covered on at least part of one of its surfaces with a stack of thin layers,
b. a step of depositing, on a part of a surface of the stack of thin layers, a layer of enamel, the deposition being carried out by screen-printing an enamel composition comprising 1 to 15% by weight of zinc oxide particles having a particle size distribution by volume such that d90 is at most 5 μm,
c. a step of bending the first glass sheet, the stack of thin layers located under the enamel layer being completely dissolved by said enamel layer at least at the end of said step c, then
d. a step of laminating said first glass sheet with an additional glass sheet by means of a lamination interlayer, so that the enamel layer faces said interlayer.

2. The method according to claim 1, wherein the stack of thin layers comprises at least one functional layer.

3. The method according to claim 15, wherein the electrically conductive functional layer is selected from metal layers, and layers of a transparent conductive oxide.

4. The method according to claim 1, wherein after step d, the enamel layer is opaque, has a black hue, and forms a strip at a periphery of the first glass sheet.

5. The method according to claim 1, wherein the zinc oxide particles have a particle size distribution by volume such that the d90 is at most 1 μm.

6. The method according to claim 1, wherein the zinc oxide particles have a particle size distribution by volume such that the d50 is between 200 and 900 nm.

7. The method according to claim 1, wherein a proportion of zinc oxide particles in the enamel composition is between 2 and 10% by weight.

8. The method according to claim 1, wherein the enamel composition further comprises refractory particles having a diameter of at least 20 μm in a volume proportion of at least 0.5%, but not particles having a diameter greater than 80 μm.

9. The method according to claim 8, wherein the refractory particles are based on metal oxides or metals.

10. The method according to claim 1, wherein the deposition of the enamel layer is carried out by screen printing using a screen printing screen having a mesh opening of at least 40 μm.

11. The method according to claim 1, wherein:
the method comprises between step b) and step c) a step b1) of pre-firing the enamel layer during which the thin layer stack located under the enamel layer is at least partially dissolved by said enamel layer, and
in step c) the first glass sheet and the additional glass sheet are curved together with the enamel layer facing said additional glass sheet .

12. The method according to claim 1, wherein the additional glass sheet bears, on the face opposite the face which is facing the lamination interlayer, an additional stack of thin layers.

13. A laminated curved glazing unit, especially for a windshield or roof of a motor vehicle, obtained by the method of claim 1, comprising a first glass sheet coated on at least part of one of its faces with a stack of thin layers, said first glass sheet being coated on part of its surface with an enamel layer comprising zinc oxide particles having a particle size distribution by volume such that the d90 is at most 5 μm, said first glass sheet being laminated with an additional glass sheet by means of a lamination interlayer), said enamel layer facing said lamination interlayer.

14. The method according to claim 1, wherein the curved laminated glazing unit is a windshield or roof of a motor vehicle.

15. The method according to claim 2, wherein the stack of thin layers comprises at least one electrically conductive functional layer.

16. The method according to claim 3, wherein the metal layers are silver or niobium layers, and the layers of a transparent conductive oxide are selected from indium tin oxide, doped tin oxides, and doped zinc oxides.

17. The method according to claim 6, wherein the zinc oxide particles have a particle size distribution by volume such that the d50 is between 300 and 800 nm.

18. The method according to claim 7, wherein a proportion of zinc oxide particles in the enamel composition is between 3 and 8% by weight.

19. The method according to claim 12, wherein the additional stack of thin layers is a stack with low emissivity comprising a transparent conductive oxide.
